(19) United States
(12) Patent Application Publication
(10) Pub. No.: US 2026/0161716 A1
(43) Pub. Date: Jun. 11, 2026

(54) USING MULTI-AGENT LANGUAGE MODELS FOR GENERATING CONTEXT-AWARE QUERY UNDERSTANDING

(71) Applicant: Maplebear Inc., San Francisco, CA (US)

(72) Inventors: Raochuan Fan, Sunnyvale, CA (US); Akshay Nair, San Francisco, CA (US); Taesik Na, Issaquah, WA (US); Xuan Zhang, Palo Alto, CA (US); Tejaswi Tenneti, San Carlos, CA (US); Yuanzheng Zhu, Smyrna, GA (US)

(21) Appl. No.: 18/970,656

(22) Filed: Dec. 5, 2024

(51) Int. Cl. G06F 16/9535; G06F 16/2452; G06F 16/2457; G06F 16/906; G06F 16/9538

(52) U.S. Cl. CPC G06F 16/9535; G06F 16/2452; G06F 16/24578; G06F 16/906; G06F 16/9538

(57) ABSTRACT

An online system utilizes multi-agent language models for context-aware understanding of a query. The online system receives the query submitted by a user during a user's session at the online system, and stores, during the session, information about the session. The online system generates a prompt for input into the language models, the prompt including the query and the information about the session. Each language model is tuned to infer a respective type of context of the query and generate, based on the prompt, a response including information about the respective type of context. The online system generates, using responses from the language models, a query understanding string with information about types of context of the query. The online system uses the query understanding string to identify a set of items and displays a user interface with items so that the user can order one or more items.

### BACKGROUND

Online systems that provide content to users often provide a search interface, which allows the users to search for items of interest. For example, an online movie database system may enable users to search for movies based on attributes, like title or actors. In another example, an online grocery delivery service may include a search interface that enables users to search for items and then place online orders. Search systems are generally designed to provide useful search results to users based on how related the results are to the users'queries.

Query understanding refers to interpreting a user's intent from a query. Conventional approaches to query understanding rely solely on search queries for interpretation, and as a result they lack context-awareness. Although conventional approaches may use traditional machine-learning models to interpret a user's search intent, they often fail to provide a robust unified model-based solution. It is therefore desirable to improve on conventional systems that are limited to static queries to achieve a context-aware query understanding.

### SUMMARY

Embodiments of the present disclosure are directed to using multi-agent language models for generating a context-aware understanding of a query submitted by a user of an online system.

In accordance with one or more aspects of the disclosure, the online system receives, via a network from a device associated with a user of the online system, a query submitted by the user during a session of the user at the online system. The online system stores, at a computer-readable medium of the online system and during the session, information about the session. Responsive to receiving the query, the online system generates a prompt for input into a plurality of language models, each of the plurality of language models tuned to infer a respective type of context of a plurality of types of context of the query, the prompt including the query and contextual data including the information about the session. The online system requests each of the plurality of language models to generate, based on the prompt input into each of the plurality of language models, a respective response of a plurality of responses that includes information about the respective type of context of the query. The online system generates, using the plurality of responses, a query understanding string for the query, the query understanding string including information about the plurality of types of context of the query. The online system identifies, from a database of the online system and using the information about the plurality of types of context, a set of one or more items. The online system generates, using information about the set of one or more items, a first user interface signal. The online system sends, via the network, the first user interface signal to the device associated with the user, wherein the sending the first user interface signal causes the device associated with the user to display a user interface with the information about the set of one or more items and one or more user interface elements for use by the user to order the set of one or more items.

The online system presented herein separates the query-based search process into a first stage that extracts multiple types of context of a session associated with a query to infer a query understanding, and then, in a second stage, the inferred query understanding is used to provide improved search results. Moreover, the first stage of inferring query understanding is performed by multiple language models, each tuned for a different type of contextual information associated with the query. This approach enables specialized language models to extract different types of context from the query (e.g., categories, attributes, query rewrites, etc.), which provides a more robust query understanding to help the search algorithm return better results that are more relevant of taking different types of contextual information into account for the user.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example architectural flow diagram of using multi-agent language models for generating a context-aware understanding of a query received from a user of an online system, in accordance with one or more embodiments.

FIG. 4 is a flowchart for a method of using multi-agent language models for generating a context-aware understanding of a query received from a user of an online system, in accordance with one or more embodiments.

### DETAILED DESCRIPTION

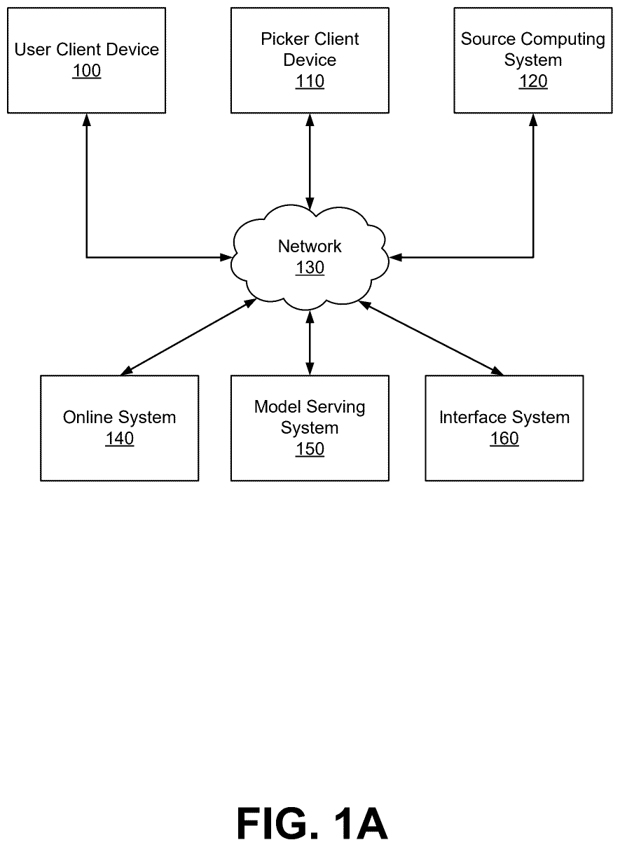

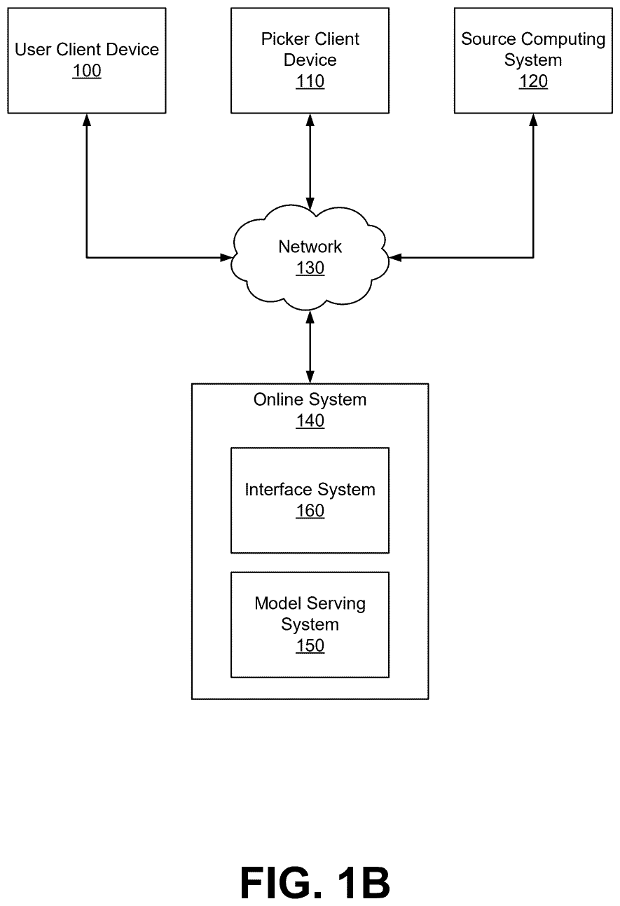

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, and an interface system 160.

Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140.

An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with an agent that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker (also referred to herein as a servicing agent, or agent) services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 includes a search engine that provides responses to user queries, e.g., search results with items available from sources associated with the online system 140. To assist the search engine, the online system 140 employs a query understanding engine that extracts a user's intent from both the user's query itself as well as contextual information from when the query was made. During a user's session with the online system 140, the online system 140 collects contextual information, such as browsing history, items interacted with, search terms used, etc. When the user submits a query, the online system 140 sends this contextual information and the query to the query understanding engine, which includes a multi-agent language model system with multiple language models each tuned for extracting a different type of context (e.g., category of item interest, attributes of interest, etc.). Thus, the online system 140 presented herein integrates the multi-agent language model system that takes into account the context of the query to interpret various user's intents in relation to the query. The extracted user intent information is packaged and provided to the search engine (or any other service of the online system 140), which uses the extracted user intent information to improve on content provided to the user in response to the user's query.

A query understanding refers to the process of interpreting and processing a user's query to accurately discern the user's intent. The query understanding engine represents an important component of the search framework of the online system 140, with signals from the query understanding widely used in retrieval and ranking of items. Due to bandwidth limitations, most of the traditional machine-learning models that perform the query understanding were not actively developed and maintained, resulting in outdated machine-learning models and inaccurate interpretations of user intent. As a result, the focus of the workstream presented in this disclosure is to revamp the power of query understanding by leveraging world knowledge and inference capabilities of language models, where several objectives can be achieved. One objective is the coverage, where the goal is to achieve a broad coverage of all possible context types (e.g., 95% coverage), while targeting a large number of queries (e.g., approximately the top 600K queries). Another objective is generalization to tail queries, i.e., less common queries. Traditional machine-learning models trained with engagement data generally perform poorly on tail queries. The online system 140 presented herein aims to address this issue by utilizing language models, which are better at generalizing to less common queries. Yet another objective is the serving of query results. Due to latency constraints, the online system 140 with the integrated multi-agent language models can generate the required output offline and serve the results via a feature store lookup. Yet another objective is the data freshness. A pipeline of the online system 140 can be scheduled to refresh language model generated data and re-tune the language models periodically to incorporate new knowledge and maintain data freshness.

The online system 140 presented herein integrates a context-aware query understanding system that utilizes a multi-agent language model framework designed to achieve better understanding of user's intent in online system environments by dynamically interpreting user queries based on context of the queries. By enhancing query understanding with greater context awareness and personalization, the online system 140 can more effectively and accurately interpret user's intent, resulting in improved search outcomes for users and driving higher engagement levels.

The usage of multi-agent language model framework by the online system 140 may provide several benefits in comparison with traditional approaches for interpreting user queries. First, the online system 140 with the integrated multi-agent language model framework may solve for context-awareness challenges that are present with traditional machine-learning models. Traditional machine-learning models often fail to achieve context-aware query processing, relying on fixed features and lacking adaptability to user-specific types of context. Second, the online system 140 with the integrated multi-agent language model framework may efficiently handle tail and broad queries. Traditional machine-learning models often struggle with tail and broad queries, leading to miss-interpreted users'intentions. Third, the online system 140 with the integrated multi-agent language model framework avoids maintenance of multiple machine-learning models. Developing and maintaining multiple machine-learning models for different intents is resource-intensive and complex, requiring constant updates and monitoring. The multi-agent language model system presented herein simplifies this by effectively managing diverse queries without the need of specialized machine-learning models.

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

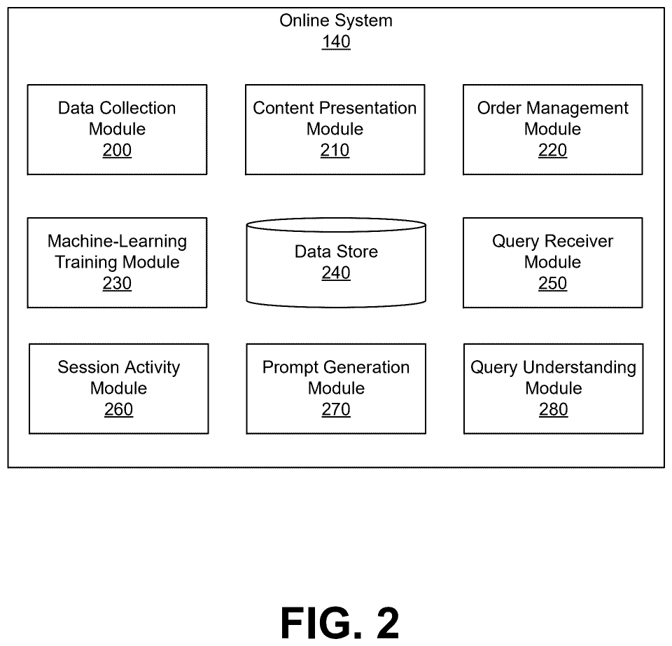

The online system 140 may employ multiple LLMs of the model serving system 150 to infer intent of a user of the online system 140 in relation to a query, where the user's intent is represented by multiple types of context. The online system 140 may prepare (e.g., via a prompt generation module 270 in FIG. 2) a prompt for input to each LLM. The prompt may include a normalized version of the query submitted by the user and contextual information in a structured format.

Each LLM may generate a corresponding response to the prompt based on execution of the machine-learning model using the prompt. The corresponding response output by each LLM may include one or more labels in a structured format for a corresponding type of context (e.g., category of item associated with the query, query rewrite, attributes of interest in relation to the query, etc.) for which each LLM has been tuned. The online system 140 may import, from the model serving system 150, the responses output by the LLMs and package the responses into a query understanding output (e.g., query understanding string). Some context-aware query understanding examples generated by prompting corresponding LLMs are provided below.

For an example query “apple” and an example source “Best Buy”, the inferred item category intent can be “electronic devices”. For an example query “dyson” and an example source “Sephora”, the inferred item category intent can be “hair product”.

For an example query “2% milk” and an example dietary preference “organic”, the rewritten query can be “low fat organic milk”. For an example query “bread” and an example dietary preference “gluten free”, the rewritten query can be “gluten free bread”.

For an example query “turkey” and an example occasion “thanksgiving”, the inferred item category intent can be “whole turkey”. For an example query “appetizers” and an example occasion “super bowl night”, the inferred query understanding can be “wings, nachos, and dips”. For an example query “appetizers” and an example occasion “Christmas”, the inferred query understanding can be “shrimp cocktail, cheese platters, or charcuterie”.

For an example query “yogurt” and an example in-session cart addition of “high-protein products”, the inferred query understanding (e.g., inferred query intent) can be “high-protein yogurt options like Greek yogurt”. For an example query “pizza” and an example in-session cart addition of “other frozen meals”, the inferred query understanding (e.g., inferred query intent) can be “frozen pizza options for convenience”.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a query receiver module 250, a session activity module 260, a prompt generation module 270, and a query understanding module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In one or more embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In one or more embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected.

Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In one or more other embodiments, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer language model using training data stored in the data store 240.

The machine-learning training module 230 may provide the transformer language model to the model serving system 150 for deployment.

The query receiver module 250 may receive a query entered by a user of the online system 140 via a user interface of the user client device 100. The query may represent a natural language query originated from the user, which can range from specific item searches (e.g., “Brand A 2% milk”) to vague or complex requests (e.g., “dinner plan”).

The session activity module 260 may receive contextual data with information about user's activity during a user's online session, such as information about searches and search terms used during the user's online session, items added to a cart, source context (e.g., information about a source, source location, etc.), occasion context (e.g., holiday, special occasion such as birthday planning, child's party, anniversary, etc.), in-session context (e.g., user's engagement data in relation to the current online session), etc. When the user submits the query, the session activity module 260 may store (e.g., at a computer readable storage medium of the session activity module 260) the aforementioned contextual data. Additionally, the session activity module 260 may store other information about the user, such as information retrieved from a user catalog database (e.g., stored at the data store 240) based on the user's account. The other information about the user stored at the session activity module 260 may include information about the user's explicit preferences (e.g., dietary preferences, price preferences, brand preferences, source preferences, etc.), information about the user's past engagements (e.g., searches, converted items, converted categories, etc.), some other user information, or some combination thereof.

The prompt generation module 270 may generate a prompt for input into each language model (e.g., LLM of the model serving system 150) of a multi-agent language model framework of the online system 140. The prompt generation module 270 may first generate an initial prompt for input into a pre-processing language model of the multi-agent language model framework. The initial prompt may include a raw query received via the network 130 from the user client device 100 and contextual information (e.g., information about in-session activity, user dietary preferences, information about a source, information about an occasion, etc.).

Based on the initial prompt, the pre-processing language model may pre-process the query and the contextual information and output a processed query and a normalized context. The processed query may be a version of the raw query that is in a normalized format, as well as a spell-corrected version of the raw query, i.e., the processed query may represent a spell-corrected query converted into a normalized format. To generate the normalized context, the pre-processing language model may convert the unstructured contextual information into a structured format. Additionally, to generate the normalized context, the pre-processing language model may add context, such as information about historical conversions by the user, e.g., obtained from application programming interfaces (APIs) of the online system 140. The output generated by the pre-processing language model including the processed query and the normalized context may be imported at the online system 140 and passed to the prompt generation module 270.

The prompt generation module 270 may use the output of the pre-processing language model to generate a prompt for input into each specialized agentic language model of a set of specialized agentic language models, where the prompt includes the processed query and the normalized context. Each agentic language model may be specialized to infer a specific type of context of the query, e.g., category, rewrites, attributes, etc. Thus, each agentic language model may be tuned specially for its corresponding type of context. Based on the prompt that includes the processed query and the normalized context, each agentic language model outputs a structured response that labels the corresponding type of context of the user's query. An example output of an agentic language model specialized to infer an item category from the user's query (i.e., query category classification language model) is [category]=alcohol/beer. Based on the same prompt including the processed query and the normalized context, the set of specialized agentic language models may infer different types of user's intentions that fit to the processed query and the normalized context.

Thus, the online system 140 presented herein utilizes the multi-agent language model framework that includes the set of specialized agentic language models, where each specialized agentic language model is prompted and trained to handle different aspects of the query's intent. The set of specialized agentic language models may analyze the input query (i.e., the processed query) alongside the contextual information (i.e., the normalized context) to understand the user's intent and specific requirements. The set of specialized agentic language models may perform collaborative processing, i.e., the set of specialized agentic language models may collaborate, share insights, and refine their outputs based on their specialized knowledge.

A query category classification language model of the set of specialized agentic language models may assign the query to category taxonomy nodes, which enables understanding of the user's intent in a hierarchical manner. The query category can be widely used for recall, filtering, and determining ads load, as well as for ranking of items for presentation to the user. The query category classification language model may leverage its general knowledge and reasoning capabilities to improve classification accuracy, thus driving relevance improvement in downstream applications. In one or more embodiments, the query category classification language model is built with the fastText algorithm and trained on historical conversion data. An example query category inferred by the query category classification language model is “Alcohol->Beer->Ales->Brand A”.

A query rewrites language model of the set of specialized agentic language models may perform a process of rewriting the original query into multiple pertinent queries, which may be then used to recall items, which is essential especially when the original query does not yield enough candidates. For example, for the user's query of “parsley flat”, the query rewrites can be “[italian parsley, parsley, curly parsley]”.

A query attributes language model of the set of specialized agentic language models may infer attributes from the user's query. For example, for the user's query of “organic gluten free bread”, the inferred attributes can be “[organic, gluten-free]”. A query tagging language model of the set of specialized agentic language models may infer tags from the user's query. For example, for the user's query of “chocolate milk”, the inferred tags can be “chocolate: attribute, milk: product”.

A query brand language model of the set of specialized agentic language models may infer a brand from the user's query. For example, for the user's query of “<Brand B>milk”, the inferred brand can be “<Brand B>: brand”. A query aisle language model of the set of specialized agentic language models may infer an aisle associated with the user's query. For example, for the user's query of “milk”, the inferred aisle can be “Dairy”.

An output generated by each specialized agentic language model of the set of specialized agentic language models may be imported at the online system 140 and then passed to the query understanding module 280. The query understanding module 280 may package outputs generated by the set of specialized agentic language models as a “query understanding” for the user's query, where the query understanding describes the query and is based on the context in which the user submitted the query. A format of the query understanding may be, for each context type, a set of one or more fields with identifiers that represent a corresponding context type of the query.

The query understanding module 280 may pass the query understanding to one or more downstream applications of the online system 140 that uses the query understanding. In one or more embodiments, a search engine of the online system 140 (e.g., as part of the order management module 220) may use the query understanding to find and rank items responsive to the user's query. Some other sub-systems of the online system 140 may use specific elements of the query understanding to generate content for the user, such as a carousel that provides items within a catalog category from the category agent context (e.g., a beer carousel).

In one or more embodiments, the model serving system 150 fine-tunes the set of specialized agentic language models using catalog data and taxonomy information (e.g., as available at the data store 240), so that each specialized agentic language model is aware of the contextual data associated with the online system 140. The model serving system 150 may further tune the set of specialized agentic language models to make each agentic language model specialized at tasks defined at the online system 140 (e.g., picking tasks, delivery tasks, etc.) by considering, e.g., user dietary preferences when interpreting the item category intent.

In one or more embodiments, the model serving system 150 periodically re-tunes the set of specialized agentic language models to periodically refresh the language model generated knowledge. For example, updating the semantic role labeling output can help capture new brands and other relevant information that may have emerged since the last update of the specialized agentic language models.

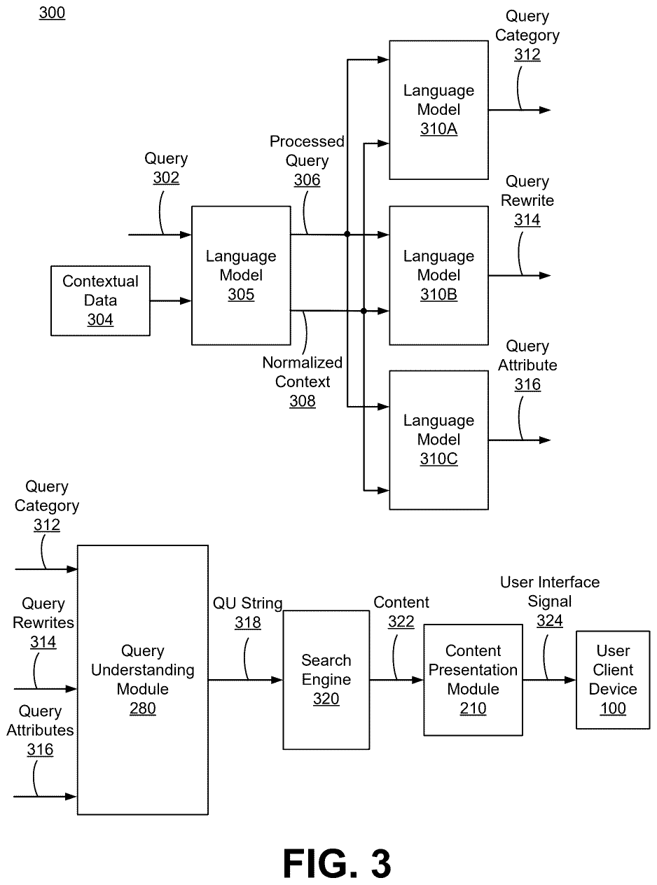

FIG. 3 illustrates an example architectural flow diagram 300 of using multi-agent language models for generating a context-aware understanding of a query received from a user of the online system 140, in accordance with one or more embodiments. The flow of operations starts when the online system 140 receives (e.g., via the query receiver module 250) a query 302 submitted by a user of the online system 140 during an online session of the user. The query 302 may be communicated via the network 130 from the user client device 100 to the online system 140.

During the user's online session, the user client device 100 may save contextual data 304 with information about the user's online session, such as searches conducted by the user, information about one or more items requested by the user, information about a source associated with the online session, information about an event associated with the online session, some other contextual information, or some combination thereof. Once the user submits the query 302 via a user interface of the user client device 100, the online system 140 downloads the contextual data 304 from the user client device 100 via the network 130. Additionally, the online system 140 may retrieve (e.g., via the session activity module 260), from the data store 240, user data with information about one or more features of the user, such as dietary preferences for the user, user's brand preferences, user's source preferences, user's price preferences, some other user data, or some combination thereof.

The prompt generation module 270 may generate a first prompt for input into a language model 305 (e.g., LLM of the model serving system 150), where the first prompt includes the query 302 and the contextual data 304 that may also include the user data. Based on the first prompt, the language model 305 may generate a processed query 306 and a normalized context 308. The processed query 306 may represent a version of the query 302 that is converted into a normalized format. Additionally, the processed query 306 may be a spell-corrected version of the query 302. The normalized context 308 may represent the contextual data 304 converted to have a structured format.

The prompt generation module 270 may generate a second prompt for input into a set of language models 310A, 310B, 310C (e.g., LLMs of the model serving system 150), where the second prompt includes the processed query 306 and the normalized context 308. Each language model 310A, 310B, 310C may be tuned to infer a corresponding type of context (e.g., type of user's intent) of the query 302 (and, equivalently, of the processed query 306). In addition to the language models 310A, 310B, 310C, the online system 140 may employ one or more additional language models each tuned to infer an additional type of context of the query 302 that is not being inferred by the language models 310A, 310B, 310C. Similarly, in one or more embodiments, at least one of the language models 310A, 310B, 310C is not used.

The language model 310A may be tuned using classification data retrieved from the data store 240 to infer, from the query 302, a category (e.g., an item category) associated with the query 302. Hence, based on the second prompt, the language model 310A may generate a response including a query category 312 indicating the category of the query 302. The language model 310B may be tuned using catalog data with a collection of features associated with a collection of items (e.g., retrieved from the data store 240) to rewrite the query 302 into a rewritten version of the query 302 including a set of fields with a set of candidate items associated with the query 302 Hence, based on the second prompt, the language model 310B may generate a response including a query rewrite 314 representing the rewritten version of the query 302. The language model 310C may be tuned using attribute data including information about a collection of attributes associated with the collection of items (e.g., retrieved from the data store 240) to infer, from the query 302, one or more attributes associated with the query 302. Hence, based on the second prompt, the language model 310C may generate a response including a query attribute 316 with information about one or more attributes associated with the query 302. The query category 312, the query rewrite 314, and the query attribute 316 generated by the language models 310A, 310B, 310C may be passed to the query understanding module 280.

The query understanding module 280 may package the query category 312, the query rewrite 314, and the query attribute 316 into a query understanding (QU) string 318. The QU string 318 may include multiple sets of one or more fields, where each set of one or more fields represents the query category 312, the query rewrite 314, or the query attribute 316. The one or more fields in each set may include one or more identifiers for a respective type of context of the query 302. Thus, the QU string 318 includes information about multiple types of context (e.g., multiple types of user's intent) of the query 302. The query understanding module 280 may pass the QU string 318 to a search engine 320. The search engine 320 may be part of the order management module 220 or some other module of the online system 140.

The search engine 320 may utilize the information about multiple types of context of the query 302 from the QU string 318 to conduct context-aware search of the data store 240 to generate content 322 for presentation to the user. The content 322 may be a list of items (e.g., ranked list of items) found in response to the query 302, a carousel of items identified using the query category 312, the query rewrite 314, and/or the query attribute 316, or some other type of context-aware content. The search engine 320 may pass information about the content 322 to the content presentation module 210.

The content presentation module 210 may generate a user interface signal 324 using the content 322. The content presentation module 210 may send, via the network 130, the user interface signal 324 to the user client device 100 that causes the user client device 100 to display a user interface with the content 322 and user interface elements for use by the user to engage with corresponding portions of the content 322 (e.g., to order one or more items for delivery).

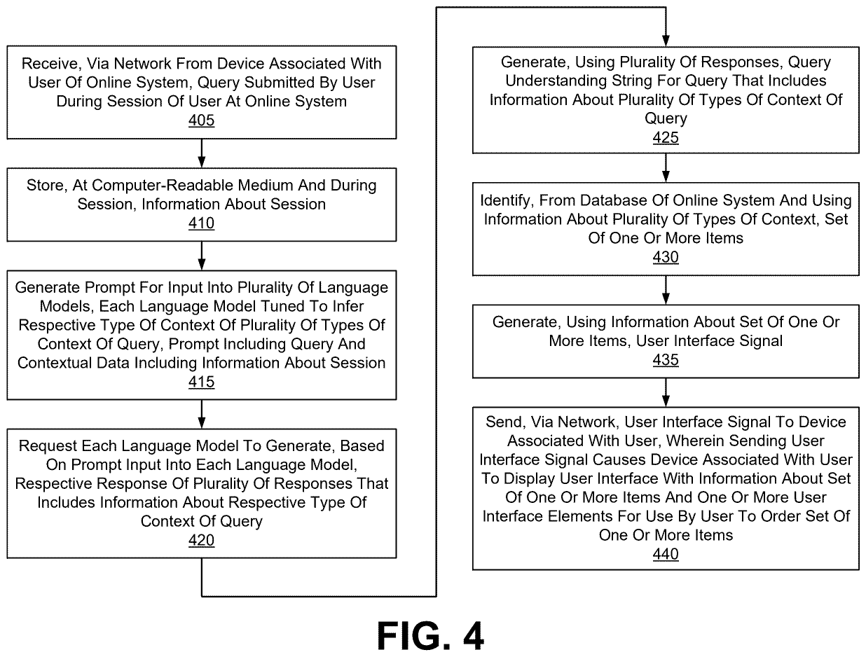

FIG. 4 is a flowchart for a method of using multi-agent language models for generating a context-aware understanding of a query received from a user of an online system, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the query receiver module 250), via a network (e.g., the network 130) from a device associated with a user of the online system 140 (e.g., the user client device 100), a query submitted by the user during a session of the user at the online system 140. The online system 140 stores 410, at a computer-readable medium of the online system 140 (e.g., at a computer-readable medium of the session activity module 260) and during the session, information about the session.

The online system 140 may receive (e.g., at the session activity module 260), from the device associated with the user and via the network, real time session data including at least one of information about one or more searches conducted by the user during the session, information about one or more items requested by the user during the session, information about a source associated with the session, or information about an event associated with the session. The online system 140 may store, at the computer-readable medium (e.g., of the session activity module 260), the real time session data.

Responsive to receiving the query, the online system 140 may retrieve (e.g., via the session activity module 260), from the database, user data including information about one or more features of the user (e.g., one or more user's dietary preferences). The online system 140 may store the information about the session by storing, at the computer-readable medium (e.g., of the session activity module 260), the user data.

Responsive to receiving the query, the online system 140 generates 415 (e.g., via the prompt generation module 270) a prompt for input into a plurality of language models, each of the plurality of language models tuned to infer a respective type of context of a plurality of types of context (e.g., user's intents) of the query, the prompt including the query and contextual data including the information about the session. The online system 140 requests 420 (e.g., via the prompt generation module 270) each of the plurality of language models to generate, based on the prompt input into each of the plurality of language models, a respective response of a plurality of responses that includes information about the respective type of context of the query. The online system 140 may request (e.g., via the prompt generation module 270) each of the plurality of language models to generate the respective response including a set of one or more fields with one or more identifiers for the respective type of context of the query.

The online system 140 generates 425 (e.g., via the query understanding module 280), using the plurality of responses, a query understanding string for the query, the query understanding string including information about the plurality of types of context of the query. The online system 140 may package (e.g., via the query understanding module 280) the plurality of responses into the query understanding string that includes a plurality of sets of one or more fields, each of the plurality of sets including one or more identifiers for the respective type of context of the query.

The online system 140 may retrieve (e.g., via the machine-learning training module 230), from the database, classification data including information about classification of a collection of items. The online system 140 may tune (e.g., via the model serving system 150), using the classification data, a first language model of the plurality of language models to infer, from the query, a category of an item associated with the query, the category of the item representing a first type of context of the plurality of types of context.

The online system 140 may retrieve (e.g., via the machine-learning training module 230), from the database, catalog data including information about a collection of features associated with the collection of items. The online system 140 may tune (e.g., via the model serving system 150), using the catalog data, a second language model of the plurality of language models to rewrite the query into a rewritten version of the query including a set of fields with a set of candidate items associated with the query, the rewritten version of the query representing a second type of context of the plurality of types of context.

The online system 140 may retrieve (e.g., via the machine-learning training module 230), from the database, attribute data including information about a collection of attributes associated with the collection of items. The online system 140 may tune (e.g., via the model serving system 150), using the attribute data, a third language model of the plurality of language models to infer, from the query, one or more attributes associated with the query, the one or more attributes representing a third type of context of the plurality of types of context.

The online system 140 may process the query (e.g., via the query receiver module 250 or some other module of the online system 140) by converting the query into a version of the query having a normalized format. The online system 140 may process (e.g., via the session activity module 260 or some other module of the online system 140) the information about the session by converting the information about the session into the contextual data having a structured format. The online system 140 may generate the prompt (e.g., via the prompt generation module 270) by including, into the prompt, the version of the query having the normalized format and the contextual data having the structured format.

The online system 140 may generate (e.g., via the prompt generation module 270) an initial prompt for input into a language model, the initial prompt including the query and the information about the session. The online system 140 may request (e.g., via the prompt generation module 270) the language model to generate, based on the initial prompt input into the language model, a response including a version of the query having a normalized format and the contextual data having a structured format. The online system 140 may generate the prompt (e.g., via the prompt generation module 270) by including, into the prompt, the version of the query having the normalized format and the contextual data having the structured format.

The online system 140 identifies 430 (e.g., via the order management module 220), from a database of the online system 140 (e.g., the data store 240) and using the information about the plurality of types of context, a set of one or more items. The online system 140 generates 435 (e.g., via the content presentation module 210), using information about the set of one or more items, a first user interface signal. The online system 140 sends 440 (e.g., via the content presentation module 210), via the network, the first user interface signal to the device associated with the user, wherein the sending the first user interface signal causes the device associated with the user to display a user interface with the information about the set of one or more items and one or more user interface elements for use by the user to order the set of one or more items.

The online system 140 may identify (e.g., via the order management module 220), from the database and using the information about the plurality of types of context within the query understanding string, a plurality of items. The online system 140 may rank (e.g., via the order management module 220), using the information about the plurality of types of context within the query understanding string, the plurality of items to generate a ranked list of items.

The online system 140 may generate (e.g., via the content presentation module 210), using information about the ranked list of items, a second user interface signal. The online system 140 may send (e.g., via the content presentation module 210), via the network, the second user interface signal to the device associated with the user, wherein the sending the second user interface signal causes the device associated with the user to display the user interface with the ranked list of items and a plurality of interface elements for use by the user to order each item from the ranked list of items.

Embodiments of the present disclosure are directed to the online system 140 that uses multi-agent language models for generating a context-aware understanding of a query received from a user of the online system 140. Multi-agent language models are used herein to extract different types of context from the user's query. Before prompting the multi-agent language models, the query and collected contextual data may be preprocessed to be suitable for input into the multi-agent language models. The query understanding generated by the multi-agent language models can be used in different downstream operations of the online system 140.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A method, performed at a computer system comprising a processor and a computer-readable medium, comprising:
receiving, via a network from a device associated with a user of an online system, a query submitted by the user during a session of the user at the online system;
storing, at the computer-readable medium and during the session, information about the session;
responsive to receiving the query, generating a prompt for input into a plurality of language models, each of the plurality of language models tuned to infer a respective type of context of a plurality of types of context of the query, wherein generating the prompt comprises:
requesting a language model to generate, based on the query and the information about the session, a response including a processed version of the query and a processed version of the information about the session, and
including the response into the prompt;
requesting each of the plurality of language models to generate, based on the prompt input into each of the plurality of language models, a respective response of a plurality of responses that includes information about the respective type of context of the query;
generating, using the plurality of responses, a query understanding string for the query, the query understanding string including information about the plurality of types of context of the query;
identifying, from a database of the online system and using the information about the plurality of types of context, a set of one or more items;
generating, using information about the set of one or more items, a first user interface signal; and
sending, via the network, the first user interface signal to the device associated with the user, wherein the sending the first user interface signal causes the device associated with the user to display a user interface with the information about the set of one or more items and one or more user interface elements for use by the user to order the set of one or more items.

2. The method of claim 1, wherein storing the information about the session comprises:
receiving, from the device associated with the user and via the network, real time session data including at least one of information about one or more searches conducted by the user during the session, information about one or more items requested by the user during the session, information about a source associated with the session, or information about an event associated with the session; and
storing, at the computer-readable medium, the real time session data.

3. The method of claim 1, further comprising:
responsive to receiving the query, retrieving, from the database, user data including information about one or more features of the user,
wherein storing the information about the session comprises storing, at the computer-readable medium, the user data.

4. The method of claim 1, wherein requesting each of the plurality of language models to generate the respective response comprises:
requesting each of the plurality of language models to generate the respective response including a set of one or more fields with one or more identifiers for the respective type of context of the query.

5. The method of claim 1, wherein generating the query understanding string comprises:
packaging the plurality of responses into the query understanding string that includes a plurality of sets of one or more fields, each of the plurality of sets including one or more identifiers for the respective type of context of the query.

6. The method of claim 1, further comprising:
retrieving, from the database, classification data including information about classification of a collection of items; and
tuning, using the classification data, a first language model of the plurality of language models to infer, from the query, a category of an item associated with the query, the category of the item representing a first type of context of the plurality of types of context.

7. The method of claim 6, further comprising:
retrieving, from the database, catalog data including information about a collection of features associated with the collection of items; and
tuning, using the catalog data, a second language model of the plurality of language models to rewrite the query into a rewritten version of the query including a set of fields with a set of candidate items associated with the query, the rewritten version of the query representing a second type of context of the plurality of types of context.

8. The method of claim 7, further comprising:
retrieving, from the database, attribute data including information about a collection of attributes associated with the collection of items; and
tuning, using the attribute data, a third language model of the plurality of language models to infer, from the query, one or more attributes associated with the query, the one or more attributes representing a third type of context of the plurality of types of context.

9. The method of claim 1, wherein generating the prompt further comprises:
processing the query by converting the query into the processed version of the query having a normalized format;
processing the information about the session by converting the information about the session into contextual data having a structured format; and
including, into the prompt, the processed version of the query having the normalized format and the contextual data having the structured format.

10. The method of claim 1, wherein generating the prompt further comprises:
generating an initial prompt for input into the language model, the initial prompt including the query and the information about the session;
requesting the language model to generate, based on the initial prompt input into the language model, the response including the processed version of the query having a normalized format and the processed version of the information about the session having a structured format; and
including, into the prompt, the processed version of the query having the normalized format and the processed version of the information about the session having the structured format.

11. The method of claim 1, further comprising:
identifying, from the database and using the information about the plurality of types of context within the query understanding string, a plurality of items;
ranking, using the information about the plurality of types of context within the query understanding string, the plurality of items to generate a ranked list of items;
generating, using information about the ranked list of items, a second user interface signal; and
sending, via the network, the second user interface signal to the device associated with the user, wherein the sending the second user interface signal causes the device associated with the user to display the user interface with the ranked list of items and a plurality of interface elements for use by the user to order each item from the ranked list of items.

12. A computer program product comprising a non-transitory computer readable storage medium having instructions encoded thereon that, when executed by a processor, cause the processor to perform steps comprising:
receiving, via a network from a device associated with a user of an online system, a query submitted by the user during a session of the user at the online system;
storing, at the non-transitory computer readable storage medium and during the session, information about the session;
responsive to receiving the query, generating a prompt for input into a plurality of language models, each of the plurality of language models tuned to infer a respective type of context of a plurality of types of context of the query, wherein generating the prompt comprises:
requesting a language model to generate, based on the query and the information about the session, a response including a processed version of the query and a processed version of the information about the session, and
including the response into the prompt;
requesting each of the plurality of language models to generate, based on the prompt input into each of the plurality of language models, a respective response of a plurality of responses that includes information about the respective type of context of the query;
generating, using the plurality of responses, a query understanding string for the query, the query understanding string including information about the plurality of types of context of the query;
identifying, from a database of the online system and using the information about the plurality of types of context, a set of one or more items;
generating, using information about the set of one or more items, a first user interface signal; and
sending, via the network, the first user interface signal to the device associated with the user, wherein sending the first user interface signal causes the device associated with the user to display a user interface with the information about the set of one or more items and one or more user interface elements for use by the user to order the set of one or more items.

13. The computer program product of claim 12, wherein the instructions further cause the processor to perform steps comprising:
receiving, from the device associated with the user and via the network, real time session data including at least one of information about one or more searches conducted by the user during the session, information about one or more items requested by the user during the session, information about a source associated with the session, or information about an event associated with the session; and
storing the information about the session by storing, at the non-transitory computer readable storage medium, the real time session data.

14. The computer program product of claim 12, wherein the instructions further cause the processor to perform steps comprising:
requesting each of the plurality of language models to generate the respective response including a set of one or more fields with one or more identifiers for the respective type of context of the query.

15. The computer program product of claim 12, wherein the instructions further cause the processor to perform steps comprising:
packaging the plurality of responses into the query understanding string that includes a plurality of sets of one or more fields, each of the plurality of sets including one or more identifiers for the respective type of context of the query.

16. The computer program product of claim 12, wherein the instructions further cause the processor to perform steps comprising:
retrieving, from the database, classification data including information about classification of a collection of items;
tuning, using the classification data, a first language model of the plurality of language models to infer, from the query, a category of an item associated with the query, the category of the item representing a first type of context of the plurality of types of context;
retrieving, from the database, catalog data including information about a collection of features associated with the collection of items;
tuning, using the catalog data, a second language model of the plurality of language models to rewrite the query into a rewritten version of the query including a set of fields with a set of candidate items associated with the query, the rewritten version of the query representing a second type of context of the plurality of types of context;
retrieving, from the database, attribute data including information about a collection of attributes associated with the collection of items; and
tuning, using the attribute data, a third language model of the plurality of language models to infer, from the query, one or more attributes associated with the query, the one or more attributes representing a third type of context of the plurality of types of context.

17. The computer program product of claim 12, wherein the instructions further cause the processor to perform steps comprising:
processing the query by converting the query into the processed version of the query having a normalized format;
processing the information about the session by converting the information about the session into contextual data having a structured format; and
including, into the prompt, the processed version of the query having the normalized format and the contextual data having the structured format.

18. The computer program product of claim 12, wherein the instructions further cause the processor to perform steps comprising:
generating an initial prompt for input into the language model, the initial prompt including the query and the information about the session;
requesting the language model to generate, based on the initial prompt input into the language model, the response including the processed version of the query having a normalized format and the processed version of the information about the session having a structured format; and
including, into the prompt, the processed version of the query having the normalized format and the processed version of the information about the session having the structured format.

19. The computer program product of claim 12, wherein the instructions further cause the processor to perform steps comprising:
identifying, from the database and using the information about the plurality of types of context within the query understanding string, a plurality of items;
ranking, using the information about the plurality of types of context within the query understanding string, the plurality of items to generate a ranked list of items;
generating, using information about the ranked list of items, a second user interface signal; and
sending, via the network, the second user interface signal to the device associated with the user, wherein the sending the second user interface signal causes the device associated with the user to display the user interface with the ranked list of items and a plurality of interface elements for use by the user to order each item from the ranked list of items.

20. A computer system comprising:
a processor; and
a non-transitory computer-readable storage medium having instructions that, when executed by the processor, cause the computer system to perform steps comprising:
receiving, via a network from a device associated with a user of an online system, a query submitted by the user during a session of the user at the online system;
storing, at the non-transitory computer-readable storage medium and during the session, information about the session;
responsive to receiving the query, generating a prompt for input into a plurality of language models, each of the plurality of language models tuned to infer a respective type of context of a plurality of types of context of the query, wherein generating the prompt comprises:
requesting a language model to generate, based on the query and the information about the session, a response including a processed version of the query and a processed version of the information about the session, and
including the response into the prompt;
requesting each of the plurality of language models to generate, based on the prompt input into each of the plurality of language models, a respective response of a plurality of responses that includes information about the respective type of context of the query;
generating, using the plurality of responses, a query understanding string for the query, the query understanding string including information about the plurality of types of context of the query;
identifying, from a database of the online system and using the information about the plurality of types of context, a set of one or more items;
generating, using information about the set of one or more items, a first user interface signal; and
sending, via the network, the first user interface signal to the device associated with the user, wherein sending the first user interface signal causes the device associated with the user to display a user interface with the information about the set of one or more items and one or more user interface elements for use by the user to order the set of one or more items.
